(19) United States
(12) Patent Application Publication
(10) Pub. No.: US 2013/0010863 A1
(43) Pub. Date: Jan. 10, 2013

(54) MERGING ENCODED BITSTREAMS

(75) Inventors: Zhenyu Wu, Plainsboro, NJ (US); Ferran Valldosera, Plainsboro, NJ (US); Adarsh Golikeri, San Diego, CA (US)

(73) Assignee: THOMSON LICENSING

(21) Appl. No.: 13/520,197

(22) PCT Filed: Dec. 10, 2010
(86) PCT No.: PCT/US2010/003141

§ 371 Date: Jul. 2, 2012

Related U.S. Application Data
(60) Provisional application No. 61/284,150, filed on Dec. 14, 2009.

(51) Int. Cl. H04N 7/26; H04N 7/32

(52) U.S. Cl. 375/240.12; 375/240.01; 375/240.24; 375/E07.198; 375/E07.243

(57) ABSTRACT

At least one implementation provides a transcoder for merging two AVC (including, for example, the SVC annex) bitstreams. Various implementations provide advantages such as, for example, avoiding full decoding of at least one bitstream and/or avoiding motion compensation during the coding of an enhancement layer block. One particular implementation includes accessing a first and a second AVC encoding of a sequence of data. The second AVC encoding differs from the first AVC encoding in quality. The particular implementation further includes merging the first AVC encoding and the second AVC encoding into a third AVC encoding that uses the SVC extension of AVC. The merging is performed such that the first and second AVC encodings occupy different layers, and the first layer is a reference layer for the second layer.

### CROSS-REFERENCE TO RELATED APPLICATIONS

This application claims the benefit of the filing date of the following U.S. Provisional application, which is hereby incorporated by reference in its entirety for all purposes: Ser. No. 61/284,150, filed on Dec. 14, 2009, and titled “Merging Two AVC/SVC Encoded Bitstreams”.

### TECHNICAL FIELD

Implementations are described that relate to coding. Various particular implementations relate to merging multiple coded streams.

### BACKGROUND

A user may have certain video content encoded and stored on a hard disk. Later on, the user may obtain another encoded version of the same video content. However, the new version may have improved quality. The user is thus presented with a situation of possibly storing two different versions of the same content.

### SUMMARY

According to a general aspect, a first AVC encoding of a sequence of data is accessed. A second AVC encoding of the sequence of data is accessed. The second AVC encoding differs from the first AVC encoding in quality. The first AVC encoding is merged with the second AVC encoding into a third AVC encoding that uses the SVC extension of AVC. The merging is performed such that the first AVC encoding occupies at least a first layer in the third AVC encoding, and the second AVC encoding occupies at least a second layer in the third AVC encoding. At least one of the first or second layers is a reference layer for the other of the first or second layers.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a block/flow diagram depicting an example of a first implementation of a transcoding system.

FIG. 2 is a block/flow diagram depicting an example of a second implementation of a transcoding system.

FIG. 3 is a block/flow diagram depicting an example of a third implementation of a transcoding system.

FIG. 4 is a block/flow diagram depicting an example of a fourth implementation of a transcoding system.

FIG. 5 is a block/flow diagram depicting an example of a fifth implementation of a transcoding system.

FIG. 6 is a block/flow diagram depicting an example of an encoding system that may be used with one or more implementations.

FIG. 7 is a block/flow diagram depicting an example of a content distribution system that may be used with one or more implementations.

FIG. 8 is a block/flow diagram depicting an example of a decoding system that may be used with one or more implementations.

FIG. 9 is a block/flow diagram depicting an example of a video transmission system that may be used with one or more implementations.

FIG. 10 is a block/flow diagram depicting an example of a video receiving system that may be used with one or more implementations.

FIG. 11 is a block/flow diagram depicting an example of a process for transcoding bitstreams.

### DETAILED DESCRIPTION

At least one implementation described in this application merges two encoded video bitstreams, one encoded with AVC, the other encoded with AVC or SVC, into a new SVC bitstream. The former AVC bitstream contains enhanced video information to the latter AVC or SVC bitstream. The new SVC bitstream is generated such that it contains a sub-bitstream that is identical to the latter AVC or SVC bitstream if possible, and the enhanced information from the former AVC bitstream is encoded as an enhancement layer(s) of the new SVC bitstream. The implementation describes a transcoding diagram for this merging process. Benefits of this particular implementation include the ability to avoid one or more of (i) decoding the AVC or SVC bitstream, (ii) motion compensation for the AVC or SVC bitstream, (iii) decoding the former AVC bitstream, or (iv) motion compensation for the former AVC bitstream.

AVC refers more specifically to the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “H.264/MPEG-4 AVC Standard” or variations thereof, such as the “AVC standard” or simply “AVC”). SVC refers more specifically to a scalable video coding (“SVC”) extension (Annex G) of the AVC standard, referred to as H.264/MPEG-4 AVC, SVC extension (the “SVC extension” or simply “SVC”).

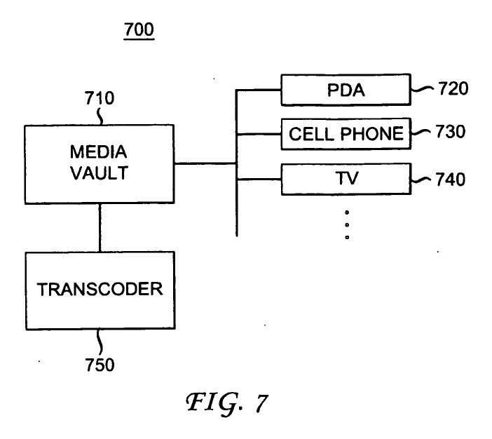

Referring to FIG. 7, and continuing with the example discussed in the background, FIG. 7 depicts a content distribution system 700 suitable for implementation in a home. The distribution system 700 includes a media vault 710 for storing content. The media vault may be, for example, a hard disk. The distribution system 700 includes multiple display devices coupled to the media vault 710 for displaying content from the media vault 710. The display devices include a personal digital assistant (“PDA”) 720, a cell phone 730, and a television (“TV”) 740. The user has stored on the media vault 710 certain video content encoded by either AVC or SVC. Later on, the user obtains another version of the same video content encoded by AVC. This version has improved quality, for example, larger resolution, higher bit rate, and/or higher frame rate. As a further example, this version may have an aspect ratio that provides better quality. The user may desire, for example, to display the new AVC version on the TV 740, while also preserving the option of displaying the lower quality version (the previously stored AVC/SVC version) on either the cell phone 730 or the PDA 720. Indeed, from a storage space standpoint, the user typically prefers to store SVC encodings that include multiple formats, because that allows different formats to be supplied to the user's different display devices 720-740, depending on the device's resolution.

As a result, the user wants to add the new AVC bitstream to the existing AVC or SVC bitstream, and wants the combined bitstream to be SVC-encoded. With SVC, the user can enjoy benefits such as, for example, easy retrieval of different versions of the same video content, smaller disk space cost, and easier media library management. The user hopes that the process will be light-weight in that it requires a limited amount of memory/disk space, and efficient in that it is fast. To assist in achieving that end, the system 700 also includes a transcoder 750 which is, in various implementations, one of the transcoders described with respect to FIGS. 2-5 below. The transcoder 750 is coupled to the media vault 710 for, for example, accessing stored encodings as input to a transcoding process and storing a transcoded output.

Assume that the new AVC bitstream contains all the video content information that the existing (AVC or SVC) video bitstream has. Furthermore, the new bitstream also contains additional quality improvement information, such as, for example, higher resolution, higher frame rate, higher bit rate, or any of their combinations. Moreover, each corresponding Access Unit (coded pictures) between the two bitstreams is temporally aligned with each other. In this context, temporal alignment means that across bit streams with different temporal resolutions, the coded pictures corresponding to the same video scene should have the same presentation time. That requirement ensures that a bit stream with higher temporal resolution contains all the scenes coded by a bit stream with lower temporal resolution. Thus, it is now possible to exploit the correlation between the coded pictures corresponding to the same scene but from different bit streams.

A first implementation for creating the new bitstream includes fully decoding the new AVC bitstream into a pixel-domain (for example, YUV) video sequence. The implementation then applies a full SVC encoding to generate the desired SVC bitstream, and the same coding parameters of the existing AVC/SVC bitstream are enforced during the full SVC encoding.

A second implementation for creating the new bitstream includes applying a transcoding process to the new AVC bitstream. That is, an AVC to SVC transcoding process is applied. Through the process, the new SVC output bitstream is generated. The new SVC output bitstream contains a sub-bitstream which is possibly identical to the existing AVC/SVC bitstream. Notice that although the AVC/SVC bitstream already exists, it is not utilized in producing the sub-bitstream.

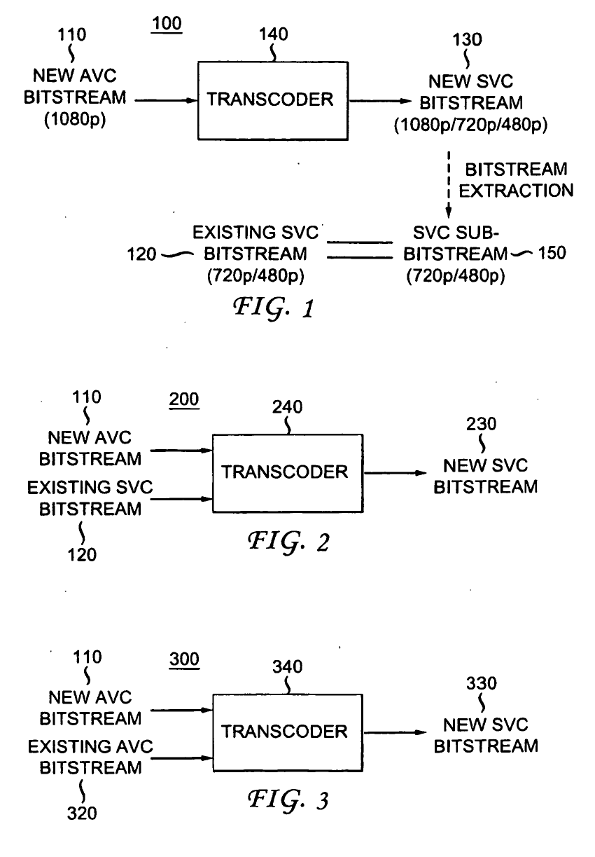

Referring to FIG. 1, a system 100 shows an example of the second implementation. The system 100 receives as input both a new AVC bitstream 110 that has a 1080p format and an existing SVC bitstream that has 720p and 480p formats. The two formats are each in different SVC spatial layers. The system 100 produces as output a new SVC bitstream 130 having all three formats of 1080p, 720p, and 480p. Each of the three formats occupies a different spatial layer. By applying a bitstream extraction process to the new SVC bitstream 130, an SVC sub-bitstream 150 is extracted that has the formats of 720p and 480p and is, in this example, the same as the input SVC bitstream 120. Compared to the first implementation that fully decodes the AVG bitstream, the system 100 of FIG. 1 saves decoding and encoding costs because the system 100 performs transcoding.

A third implementation is now discussed. Although both the first and second implementations are effective, the third implementation is typically more efficient. The increased efficiency is due to the third implementation typically being less computationally intensive and thus time-consuming than the first and second implementations. Additionally, the increased efficiency is due to the third implementation typically requiring less memory/disk space to store, for example, temporary coding results.

Referring to FIGS. 2 and 3, there are shown two examples of the third implementation. FIG. 2 provides an example in which the existing bitstream is an SVC bitstream. FIG. 3 provides an example in which the existing bitstream is an AVC bitstream.

Referring to FIG. 2, a system 200 receives as input both the new AVC bitstream 110, and the existing SVC bitstream 120. The system 200 produces as output a new SVC bitstream 230, which may be the same as the SVC bitstream 130 of FIG. 1. A sub-stream of the output bitstream 230 is identical to the input existing SVC bitstream 120. An encoded enhancement layer(s) of the output bitstream 230 contains the additional video content information from the new AVC bitstream 110. The output bitstream 230 is produced using a transcoder 240. The transcoder 240 receives two input bitstreams, whereas the transcoder 140 of FIG. 1 receives only a single bitstream as input.

Referring to FIG. 3, a system 300 receives as input both the new AVC bitstream 110, and an existing AVC bitstream 320. The system 300 produces as output a new SVC bitstream 330. A sub-stream of the output bitstream 330 is identical to the input existing AVC bitstream 320. An encoded enhancement layer(s) of the output bitstream 330 contains the additional video content information from the new AVC bitstream 110. The output bitstream 330 is produced using a transcoder 340. The transcoder 340, as with the transcoder 240, receives two input bitstreams, whereas the transcoder 140 of FIG. 1 receives only a single bitstream as input.

One aspect of the transcoders 240, 340 is that the transcoders 240, 340 can reuse the coded information from both the new AVC bitstream 110 and the existing AVC/SVC bitstreams 120, 320. This reuse is performed in order to derive the enhancement layer(s) of the new output SVC bitstreams 230, 330. As suggested earlier, the transcoders 240, 340 are typically different from a traditional transcoder, because the latter usually has only one coded bitstream as its main input, as shown in FIG. 1.

Implementations of the transcoders 240, 340 may reuse the information contained in the input bitstreams in a variety of manners. These variety of manners involve tradeoffs between, for example, the implementation complexity and performance.

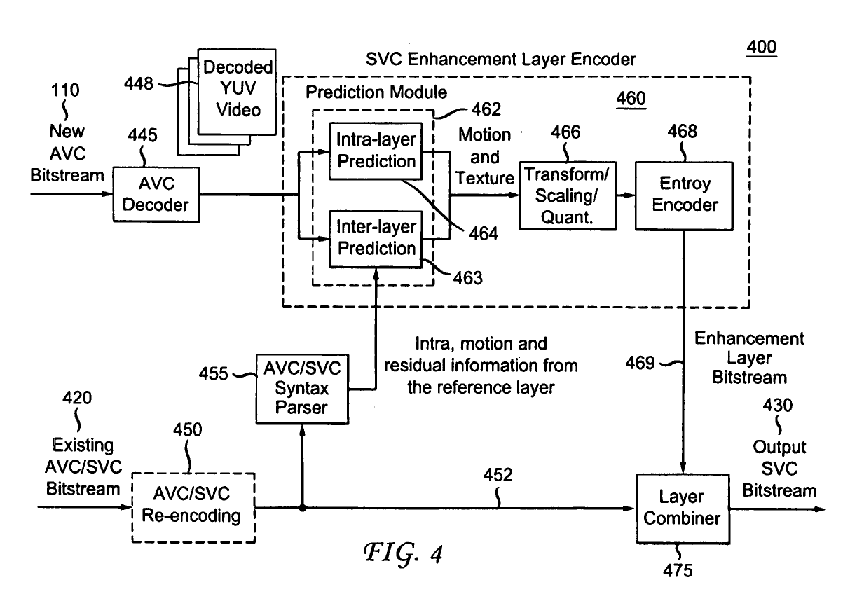

Referring to FIG. 4, there is shown a first implementation for reusing information from the input bitstreams. The dash-line bordered modules in the figures, including but not limited to FIG. 4, are optional operations. FIG. 4 includes a system 400 that receives as input both the new AVC bitstream 110 and an existing AVC/SVC bitstream 420. The bitstream 420 may be either an AVC bitstream or an SVC bitstream, and may be, for example, the existing SVC bitstream 120 or the existing AVC bitstream 320. The system 400 produces as output an output SVC bitstream 430. The SVC bitstream 430 may be, for example, any of the SVC bitstreams 130, 230, or 330. The system 400 provides an implementation of either of the transcoders 240, 340.

The system 400 includes an AVC decoder 445 that fully decodes the input new AVC bitstream 110 into a YUV video sequence. The output is referred, in FIG. 1, as decoded YUV video 448.

The system 400 also includes an optional AVC/SVC re-encoder 450. The re-encoder 450 operates on the input existing AVC/SVC bitstream 420 and re-encodes any picture/slice/macroblock (“MB”) in the existing bitstream that does not conform to the coding requirement(s) as a reference layer. An example of this may be that an intra-coded MB in the highest enhancement layer has to be encoded into “constrained intra” mode as required by a reference layer, in order to satisfy the single-loop decoding requirement.

The re-encoder 450 may be required because the coding parameters, or requirements, are different for a reference layer as compared to a non-reference layer. Additionally, a layer from the AVC/SVC bitstream 420 might not be a reference layer in the bitstream 420, but that layer might be used as a reference layer in the merged output SVC bitstream 430. Thus, that layer would be re-encoded by the re-encoder 450. The re-encoder 450 is optional because, for example, the layers of the input AVC/SVC bitstream 420 may already have been used as reference layers in the AVC/SVC bitstream 420. Determining how many, and which, layers or pictures to re-encode from the AVC/SVC bitstream 420 is generally an implementation issue. One can choose to “re-encode” more layers or pictures in the AVC/SVC bitstream 420, so that the new bit stream has more reference candidates to choose from, and vice versa. Note that the “re-encoding” is, in at least one implementation, a type of transcoding that changes the intra-coded macroblocks in the AVC/SVC bitstream 420, if any, into constrained intra-coded macroblocks. The output of the re-encoder 450 is referred to as a reference layer bitstream 452. It is to be understood that the reference layer bitstream 452 may be the same as the existing AVC/SVC bitstream 420 if, for example, no re-encoding is needed for the existing AVC/SVC bitstream 420.

The system 400 includes an AVC/SVC syntax parser 455 that receives the reference layer bitstream 452. The AVC/SVC syntax parser 455 extracts from the reference layer bitstream 452 the relevant information about intra-coded MBs, motion, and residual signals. The relevant information from the reference layers is well-known as the input to a standard SVC Enhancement Layer Encoder.

The system 400 includes an enhancement layer encoder 460. The enhancement layer encoder 460 receives the extracted information from the AVC/SVC syntax parser 455. The enhancement layer encoder 460 also receives the fully decoded YUV video sequence 448. The enhancement layer encoder 460 is the same as the typical enhancement layer encoder in a normal SVC encoder. In particular, the enhancement layer encoder 460 includes a prediction module 462 that includes an inter-layer predictor 463 that exploits correlation across layers and an intra-layer predictor 464 that exploits correlation within layers. Further, the enhancement layer encoder 460 includes a transform/scaling/quantizing module 466 that receives the output from the prediction module 462 and handles prediction residues resulting from predictions (both inter-layer, and intra-layer). The transform/scaling/quantizing module 466 handles prediction residues by applying a transform to concentrate residual picture energy to a few coefficients, then performs scaling and quantization to produce a desired bit rate. Additionally, the enhancement layer encoder 460 includes an entropy encoder 468 that receives the output from the transform/scaling/quantizing module 466, and removes the subsequent statistical redundancies within the encoded motion information and quantized residual signals. The entropy encoder 468 produces an enhancement layer bitstream 469 that is output from the enhancement layer encoder 460.

The system 400 also includes a layer combiner 475 that receives the enhancement layer bitstream 469 and the reference layer bitstream 452. The layer combiner 475 merges the encoded enhancement layer bitstream 469 with the reference layer bitstream 452. The layer combiner 475 outputs the desired new SVC bitstream 430.

As explained above, and as shown in FIG. 4, the system 400 uses an SVC enhancement layer encoder without any change to the SVC enhancement layer encoder. This greatly reduces the implementation complexity. The system 400 is effective and efficient. However, the system 400 does perform full decoding of the new input AVC bitstream 110, and encoding of the enhancement layer. As such, the system 400 does not exploit coded information from the new input AVC bitstream 110.

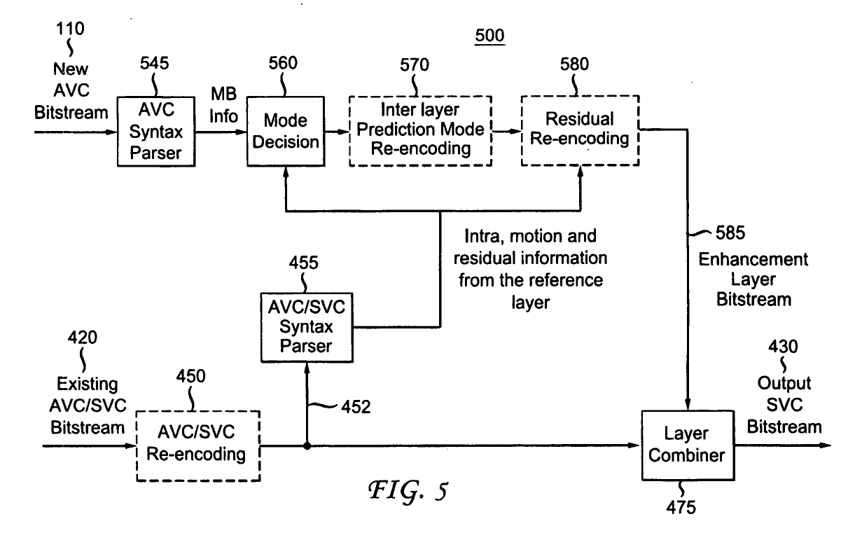

Referring FIG. 5, there is shown a second implementation for reusing information from the input bitstreams. FIG. 5 includes a system 500 that, as with the system 400, receives as input both the new AVC bitstream 110 and the existing AVC/SVC bitstream 420. The system 500 produces as output the output SVC bitstream 430. The system 500 provides an implementation of either of the transcoders 240, 340. As will be explained below, the system 500, in contrast to the system 400, does exploit coded information from the input AVC bitstream 110. Additionally, as will be seen in FIG. 5, the system 500 operates in the compressed domain which reduces complexity as compared to operating in the spatial domain.

The lower portion (as shown in FIG. 5) of the system 500 corresponds generally to the operation on the existing AVC/SVC bitstream 430 and is the same as in the system 400. That is, the system 500 provides the AVC/SVC bitstream 420 to the re-encoder 450. The re-encoder 450 produces the reference layer bitstream 452, and provides the reference layer bitstream 452 to both the AVC/SVC syntax parser 455 and the layer combiner 475.

The upper half (as shown in FIG. 5) of the system 500, however, is different from the system 400. The upper half corresponds generally to the operation on the new AVC bitstream 110.

The system 500 includes, in the upper half, an AVC syntax parser 545 that receives the input new AVC bitstream 110. The AVC syntax parser 545 extracts the coding information in the compressed domain for each MB. The coding information includes, for example, information indicating the coding mode, the motion (for example, the motion vectors), and the residual signal (for example, the DCT coefficients that code the residual signal). The extracted coding information allows the system 500 to calculate the coding cost of the original coding mode (as explained more fully below). The extracted coding information also allows the system 500 to re-encode the MB with an inter-layer prediction mode, if such an inter-layer prediction mode has a better coding cost than the original coding mode (as explained more fully below).

The system 500 includes a mode decision module 560 that receives the extracted coding information from the AVC syntax parser 545. The mode decision module 560 also receives from the AVC/SVC syntax parser 455 the corresponding information extracted from the co-located MB in the reference layer. The reference layer is from the existing AVC/SVC bitstream 420.

The mode decision module 560 evaluates coding modes for each MB within the new AVC bitstream 110. The mode decision module 560 calculates and compares the coding cost associated with the MB's original coding mode in the AVC bitstream 110, as well as the coding cost that would result if the MB were to be coded in one or more of the inter-layer prediction modes available to be used from SVC.

The system 500 includes an optional inter-layer prediction mode re-encoder 570. If the mode decision module 560 determines that one of the SVC inter-layer prediction modes has the lowest coding cost, then the particular MB being evaluated from the AVC bitstream 110 is re-encoded with the selected inter-layer prediction mode. The inter-layer prediction mode re-encoder 570 performs that re-encoding.

If the mode decision module 560 determines, for a given MB, that the original coding mode from the AVC bitstream 110 has the lowest coding cost, then no re-encoding of that MB is needed. Accordingly, the inter-layer prediction mode re-encoder 570 is bypassed, or is treated as a pass-through. In this case, the given MB retains the coding from the new AVC bitstream 110 and is not dependent on (that is, does not use as a reference) the existing AVC/SVC bitstream 420.

The system 500 includes an optional residual re-encoder 580. The residual re-encoder 580 determines whether there are coded residual signals associated with the particular MB. If there are coded residual signals, then the residual re-encoder 580 attempts to further reduce the redundancy by using the SVC inter-layer residual prediction mechanism. This is a standard SVC encoding step that is well-known to those of ordinary skill in the art. The residual re-encoder 580 receives and operates on either (i) the re-encoded output from the inter-layer prediction mode re-encoder 570, or (ii) if the inter-layer prediction mode re-encoder 570 has been bypassed, the original coding of the MB from the AVC bitstream 110. The output of the residual re-encoder 580 is an enhancement layer bitstream 585, which may be the same as the enhancement layer bitstream layer bitstream 469. Note that if there are no coded residual signals, then the residual re-encoder 580 may be bypassed, or treated as a pass-through.

The layer combiner 475 combines (also referred to as merges) the enhancement layer bitstream 585 and the reference layer bitstream 452. The combined bitstream is output from the layer combiner 475 as the output SVC bitstream 430. Compared to the system 400, the system 500 utilizes the coded information from the new AVC bitstream 110 to assist the enhancement layer encoding, so that the overall complexity and memory/disk space requirement are typically reduced. The system 400 is referred to as a pixel domain transcoder, whereas the system 500 is referred to as a syntax domain transcoder.

As discussed above, the mode decision module 560 performs the cost calculation for various modes. One implementation is now discussed, although it is clear that other implementations, as well as other details of this discussed implementation, are well within the level of ordinary skill in the art. The coding cost of the existing coding mode from the AVC bitstream 110 can be determined by examining the bits required for coding the residue for the MB under consideration. In another implementation, all bits are considered in calculating the cost, including bits required for indicating the coding mode, providing motion vectors, and indicating reference pictures, etc. However, the bits required for the residue will often determine whether or not the coding cost is lowest or not among the available modes. Implementations may determine coding cost in any manner that allows various different coding modes to be compared. For implementations operating in the compressed domain, it will often be sufficient, and possible, to compare the coding cost of various coding modes without computing the exact coding costs of those modes.

The coding cost for other SVC modes is also calculated by the mode decision module 560. In one implementation, the following analysis is performed to calculate coding costs. Three different types of enhancement layer coding (the coding of the MB from the existing AVC bitstream 110 using the existing AVC/SVC bitstream 420 as a reference) are considered: inter-coding, intra-coding, and residual re-encoding. This implementation is not necessarily optimal, in that all possible coding modes are not expressly evaluated. However, other implementations do evaluate all possible coding modes and are, therefore, optimal.

Inter-coding is considered for coding the enhancement layer MB if both the enhancement layer original coding mode is an inter-coding mode and if the base layer coding mode is an inter-coding mode. For this scenario, the enhancement layer borrows motion information, including motion vectors, reference frame indices, and partition sizes, and does not perform a full reconstruction of the base layer. This provides an advantage in reduced computational complexity. The borrowed motion vector is used to find a predictor for the enhancement layer. As a result, a search in the reference frame is not performed to find the appropriate motion vector. This provides yet another advantage in reduced computational complexity, because motion compensation (the search for the motion vector) is frequently a computationally intensive operation. The predictor provided by the base layer motion information is used, and a residue is computed. This scenario does involve decoding the enhancement layer in order to be able to compute the residue based on the base layer predictor. After computing the residue, the coding cost for that inter-coding mode can be evaluated.

Intra-coding is considered for coding the enhancement layer MB if both the enhancement layer original coding mode is an intra-coding mode and if the base layer coding mode is an intra-coding mode. For this scenario, the co-located base layer MB is decoded (reconstructed) so that it can be used as a predictor (a reference) for the enhancement layer. Partitioning sizes are borrowed from the base layer. Further, the enhancement layer MB is also decoded. However, no motion compensation is required. Once the residue is computed, with respect to the base layer predictor, the coding cost for that intra-coding mode can be determined.

Residual re-encoding is considered for all modes that produce a residue. Specifically, the residue from the co-located base layer MB is used as a predictor of the enhancement layer residue. The DCT coefficients for the base layer are examined, the base layer residue is reconstructed and upsampled to the resolution of the enhancement layer, and the upsampled reconstruction is used as a predictor for the enhancement layer residue. A new residue is then calculated, based on the base layer residue predictor. The new residue will typically offer coding gains, and thus reduce the coding cost. Of course, if the coding cost is not reduced, then the residual re-encoding can be skipped and the prior coding result can be used.

It should be clear that in residual re-encoding, each macroblock from the enhancement layer is first coded with a selected coding mode that could be either an intra-coding mode or an inter-coding mode (or, as discussed earlier, the original coding mode from the new AVC bitstream 110). However, the further operation of residual re-encoding is performed, as described above. As stated earlier, “residual re-encoding” typically offers coding gains, and therefore lowers coding cost.

In practice, residual re-encoding may be applied to any intra-coding mode or inter-coding mode. The mode decision module 560, in one implementation, performs two cost calculations for any intra-coding mode or inter-coding mode (as well as for the original coding mode of the new AVC bitstream 110). The first cost calculation is without the additional residual re-encoding operation. The second cost is with the additional residual re-encoding operation. Additionally, it is worth noting that residual re-encoding does not require motion compensation. Residual re-encoding does require decoding the base layer residue (and, if the original coding mode from the new AVC bitstream 110 is being considered, decoding of the original enhancement layer residue). However, residual re-encoding does not require a full reconstruction of the base layer (or of the enhancement layer). A full reconstruction would also typically require a determination of the predictor for the base layer (or enhancement layer) and adding the decoded residue to the base layer (or enhancement layer) predictor.

It is also worth noting that the system 400 does not require motion compensation for inter-coding modes that borrow the motion information from the co-located base layer MB. Additionally, the system 400 does not require decoding the base layer MB if an inter-coding mode is used to code the enhancement layer MB.

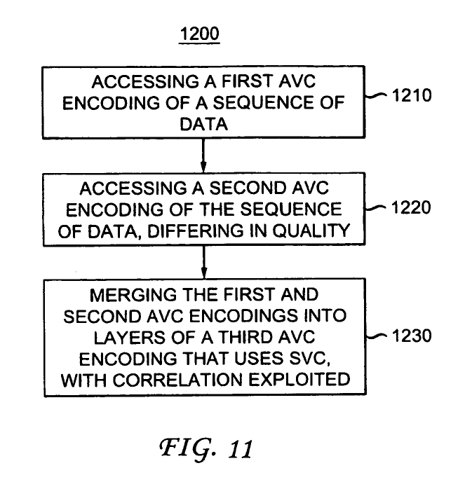

Referring to FIG. 11, a process 1200 is shown that provides an example of an implementation for transcoding bitstreams. The process 1200 includes accessing a first AVC encoding of a sequence of data (1210), and accessing a second AVC encoding of the sequence of data (1220). The second AVC encoding differs from the first AVC encoding in quality.

The process 1200 includes merging the first AVC encoding and the second AVC encoding into a third AVC encoding that uses the SVC extension of AVC (1230). The merging is performed such that (i) the first AVC encoding occupies at least a first layer in the third AVC encoding, (ii) the second AVC encoding occupies at least a second layer in the third AVC encoding, and (iii) at least some correlation between the first and second layers is exploited by using at least one of the first or second layers as a reference layer for the other of the first or second layers.

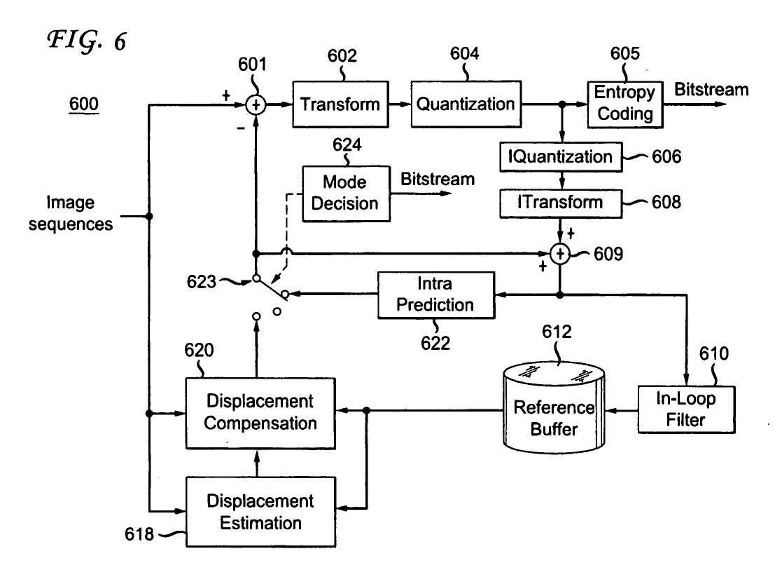

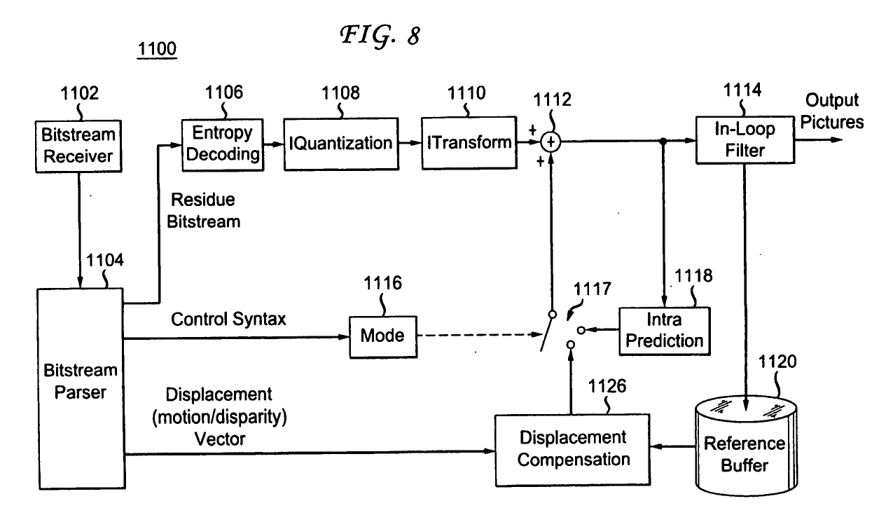

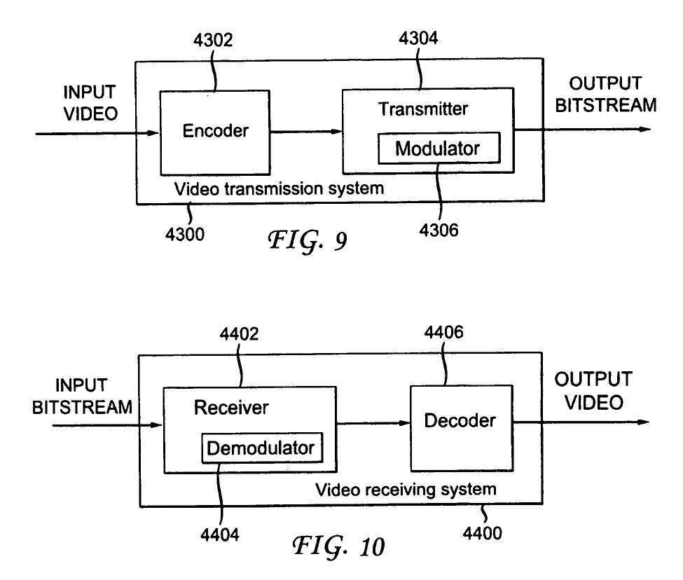

The process 1200 may be used, for example, by the transcoders of any of the systems 200, 300, 400, 500, or 700. Further, the process 1200 may be used, for example, to merge bitstreams (i) stored on the media vault 710, (ii) output by a receiver such as that described in FIG. 10 below, and/or (ii) encoded by an encoder such as that described in FIG. 6 or FIG. 9 below. Additionally, the process 1200 may be used, for example, to provide a merged bitstream for (i) storage on the media vault 710, (ii) transmission by a transmitter such as that described in FIG. 9 below, and/or (iii) decoding by a decoder such as that described in FIG. 8 or FIG. 10 below. Accordingly, it should be clear that in various implementations a transcoder, or other appropriately configured processing device, is included (i) at the output of the encoder 600 of FIG. 6, (ii) at the input of the decoder 1100 of FIG. 8, (iii) between the encoder 4302 and the transmitter 4304 of FIG. 9, and/or (iv) between the receiver 4402 and the decoder 4406 of FIG. 10.

Referring to FIG. 6, an encoder 600 depicts an implementation of an encoder that may be used to encode images such as, for example, video images or depth images. In one implementation, the encoder 600 encodes the images forming the new AVC bitstream 110. The encoder 600 may also be used to encode data, such as, for example, metadata providing information about the encoded bitstream. The encoder 600 may be implemented as part of, for example, a video transmission system as described below with respect to FIG. 9. An input image sequence arrives at adder 601 as well as at displacement compensation block 620 and displacement estimation block 618. Note that displacement refers, for example, to either motion or disparity. Another input to the adder 601 is one of a variety of possible reference picture information received through switch 623.

For example, if a mode decision module 624 in signal communication with the switch 623 determines that the encoding mode should be intra-prediction with reference to the same block or slice currently being encoded, then the adder receives its input from intra-prediction module 622. Alternatively, if the mode decision module 624 determines that the encoding mode should be displacement compensation and estimation with reference to a block or slice that is different from the block or slice currently being encoded, then the adder receives its input from displacement compensation module 620.

The adder 601 provides a signal to the transform module 602, which is configured to transform its input signal and provide the transformed signal to quantization module 604. The quantization module 604 is configured to perform quantization on its received signal and output the quantized information to an entropy encoder 605. The entropy encoder 605 is configured to perform entropy encoding on its input signal to generate a bitstream. The inverse quantization module 606 is configured to receive the quantized signal from quantization module 604 and perform inverse quantization on the quantized signal. In turn, the inverse transform module 608 is configured to receive the inverse quantized signal from module 606 and perform an inverse transform on its received signal. Modules 606 and 608 recreate or reconstruct the signal output from adder 601.

The adder or combiner 609 adds (combines) signals received from the inverse transform module 608 and the switch 623 and outputs the resulting signals to intra prediction module 622 and in-loop filter 610. Further, the intra prediction module 622 performs intra-prediction, as discussed above, using its received signals. Similarly, the in-loop filter 610 filters the signals received from adder 609 and provides filtered signals to reference buffer 612, which provides image information to displacement estimation and compensation modules 618 and 620.

Metadata may be added to the encoder 600 as encoded metadata and combined with the output bitstream from the entropy coder 605. Alternatively, for example, unencoded metadata may be input to the entropy coder 605 for entropy encoding along with the quantized image sequences.

Referring to FIG. 8, a decoder 1100 depicts an implementation of a decoder that may be used to decode images and provide them to, for example, a display device such as the TV 740. The decoder 1100 may also be used to decode, for example, metadata providing information about the decoded bitstream. The decoder 1100 may be implemented as part of, for example, a video receiving system as described below with respect to FIG. 10.

The decoder 1100 can be configured to receive a bitstream using bitstream receiver 1102, which in turn is in signal communication with bitstream parser 1104 and provides the bitstream to parser 1104. The bit stream parser 1104 can be configured to transmit a residue bitstream to entropy decoder 1106, transmit control syntax elements to mode selection module 1116, and transmit displacement (motion/disparity) vector information to displacement compensation module 1126. The inverse quantization module 1108 can be configured to perform inverse quantization on an entropy decoded signal received from the entropy decoder 1106. In addition, the inverse transform module 1110 can be configured to perform an inverse transform on an inverse quantized signal received from inverse quantization module 1108 and to output the inverse transformed signal to adder or combiner 1112.

Adder 1112 can receive one of a variety of other signals depending on the decoding mode employed. For example, the mode decision module 1116 can determine whether displacement compensation or intra prediction encoding was performed on the currently processed block by the encoder by parsing and analyzing the control syntax elements. Depending on the determined mode, mode selection control module 1116 can access and control switch 1117, based on the control syntax elements, so that the adder 1112 can receive signals from the displacement compensation module 1126 or the intra prediction module 1118.

Here, the intra prediction module 1118 can be configured to, for example, perform intra prediction to decode a block or slice using references to the same block or slice currently being decoded. In turn, the displacement compensation module 1126 can be configured to, for example, perform displacement compensation to decode a block or a slice using references to a block or slice, of the same frame currently being processed or of another previously processed frame that is different from the block or slice currently being decoded.

After receiving prediction or compensation information signals, the adder 1112 can add the prediction or compensation information signals with the inverse transformed signal for transmission to an in-loop filter 1114, such as, for example, a deblocking filter. The in-loop filter 1114 can be configured to filter its input signal and output decoded pictures. The adder 1112 can also output the added signal to the intra prediction module 1118 for use in intra prediction. Further, the in-loop filter 1114 can transmit the filtered signal to the reference buffer 1120. The reference buffer 1120 can be configured to parse its received signal to permit and aid in displacement compensation decoding by element 1126, to which the reference buffer 1120 provides parsed signals. Such parsed signals may be, for example, all or part of various images.

Metadata may be included in a bitstream provided to the bitstream receiver 1102. The metadata may be parsed by the bitstream parser 1104, and decoded by the entropy decoder 1106. The decoded metadata may be extracted from the decoder 1100 after the entropy decoding using an output (not shown).

Referring now to FIG. 9, a video transmission system/apparatus 4300 is shown, to which the features and principles described above may be applied. The video transmission system 4300 may be, for example, a head-end or transmission system for transmitting a signal using any of a variety of media, such as, for example, satellite, cable, telephone-line, or terrestrial broadcast. The transmission may be provided over the Internet or some other network. The video transmission system 4300 is capable of generating and delivering, for example, video content and other content such as, for example, indicators of depth including, for example, depth and/or disparity values.

The video transmission system 4300 includes an encoder 4302 and a transmitter 4304 capable of transmitting the encoded signal. The encoder 4302 receives video information, which may include, for example, images and depth indicators, and generates an encoded signal(s) based on the video information. The encoder 4302 may be, for example, one of the encoders described in detail above. The encoder 4302 may include sub-modules, including for example an assembly unit for receiving and assembling various pieces of information into a structured format for storage or transmission. The various pieces of information may include, for example, coded or uncoded video, coded or uncoded depth indicators and/or information, and coded or uncoded elements such as, for example, motion vectors, coding mode indicators, and syntax elements.

The transmitter 4304 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers using modulator 4306. The transmitter 4304 may include, or interface with, an antenna (not shown). Further, implementations of the transmitter 4304 may include, or be limited to, a modulator.

Referring now to FIG. 10, a video receiving system/apparatus 4400 is shown to which the features and principles described above may be applied. The video receiving system 4400 may be configured to receive signals over a variety of media, such as, for example, satellite, cable, telephone-line, or terrestrial broadcast. The signals may be received over the Internet or some other network.

The video receiving system 4400 may be, for example, a cell-phone, a computer, a set-top box, a television, or other device that receives encoded video and provides, for example, decoded video for display to a user or for storage. Thus, the video receiving system 4400 may provide its output to, for example, a screen of a television such as the TV 740, a computer monitor, a computer (for storage, processing, or display), the media vault 710, or some other storage, processing, or display device.

The video receiving system 4400 is capable of receiving and processing video content including video information. The video receiving system 4400 includes a receiver 4402 capable of receiving an encoded signal, such as for example the signals described in the implementations of this application, and a decoder 4406 capable of decoding the received signal.

The receiver 4402 may be, for example, adapted to receive a program signal having a plurality of bitstreams representing encoded pictures. Typical receivers perform functions such as, for example, one or more of receiving a modulated and encoded data signal, demodulating the data signal from one or more carriers using a demodulator 4404, de-randomizing the energy in the signal, de-interleaving the data in the signal, and error-correction decoding the signal. The receiver 4402 may include, or interface with, an antenna (not shown). Implementations of the receiver 4402 may include, or be limited to, a demodulator.

The decoder 4406 outputs video signals including, for example, video information. The decoder 4406 may be, for example, the decoder 1100 described in detail above.

Various implementations refer to “images”, “video”, or “frames”. Such implementations may, more generally, be applied to “pictures”, which may include, for example, any of various video components or their combinations. Such components, or their combinations, include, for example, luminance, chrominance, Y (of YUV or YCbCr or YPbPr), U (of YUV), V (of YUV), Cb (of YCbCr), Cr (of YCbCr), Pb (of YPbPr), Pr (of YPbPr), red (of RGB), green (of RGB), blue (of RGB), S-Video, and negatives or positives of any of these components. A “picture” may also refer, for example, to a frame, a field, or an image. The term “pictures” may also, or alternatively, refer to various different types of content, including, for example, typical two-dimensional video, a disparity map for a 2D video picture, or a depth map that corresponds to a 2D video picture.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, identifying the information, or retrieving the information from memory.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C” and “at least one of A, B, or C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

One or more implementations having particular features and aspects are thereby provided. However, variations of these implementations and additional applications are contemplated and within our disclosure, and features and aspects of described implementations may be adapted for other implementations.

For example, these implementations may be extended to merge groups of three or more bitstreams. These implementations may also be extended to apply to different standards beyond AVC and SVC, such as, for example, the extension of H.264/MPEG-4 AVC (AVC) for multi-view coding (MVC) (Annex H of the AVC standard), MPEG-2, the proposed MPEG/JVT standards for 3-D Video coding (3DV) and for High-Performance Video Coding (HVC), and MPEG-C Part 3 (International Organization for Standardization (ISO)/International Electrotechnical Commission (IEC) 23002-3). Additionally, other standards (existing or future) may be used. Of course, the implementations and features need not be used in a standard. Additionally, the present principles may also be used in the context of coding video and/or coding other types of data, such as, for example, depth data or disparity data.

As a further example, another implementation uses a new SVC bitstream in place of the new AVC bitstream 110. This implementation allows two SVC bitstreams to be merged, or a new SVC bitstream and an existing AVC bitstream.

In yet another implementation, the new bitstream (whether AVC or SVC) is of lower quality than the existing bitstream (whether AVC or SVC). In one such implementation, the new bitstream is used as the base layer in the merged bitstream.

In another variation of the above implementations, a first bitstream is an AVC bitstream, and a second bitstream is an SVC bitstream having two quality formats. The first of the two quality formats is lower quality than the AVC bitstream. The second of the two quality formats is higher quality than the AVC bitstream. In the merged bitstream, the first of the two quality formats (of the SVC bitstream) is used as a base layer for the first bitstream.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

1. A method comprising:
accessing a first AVC encoding of a sequence of data;
accessing a second AVC encoding of the sequence of data, the second AVC encoding differing from the first AVC encoding in quality; and
merging the first AVC encoding and the second AVC encoding into a third AVC encoding that uses the SVC extension of AVC, such that the first AVC encoding occupies at least a first layer in the third AVC encoding, and the second AVC encoding occupies at least a second layer in the third AVC encoding, and wherein at least one of the first or second layers is a reference layer for the other of the first or second layers.

2. The method of claim 1 wherein merging comprises parsing syntax for the first AVC encoding.

3. The method of claim 2 wherein merging further comprises performing enhancement layer coding for a given macroblock based on the parsed syntax without reconstructing a macroblock of the first AVC encoding corresponding to the parsed syntax.

4. The method of claim 3 wherein:
the enhancement layer coding is performed on the first AVC encoding, and
the enhancement layer coding of the given macroblock uses the coding mode of the first AVC encoding for the given macroblock, without reconstructing the given macroblock.

5. The method of claim 3 wherein:
the enhancement layer coding is performed on the second AVC encoding using the first AVC encoding as a base layer, and
the enhancement layer coding of the given macroblock uses motion information from the first AVC encoding for a macroblock collocated with the given macroblock, without reconstructing the given macroblock.

6. The method of claim 2 wherein merging further comprises parsing syntax for the second AVC encoding.

7. The method of claim 6 wherein:
the enhancement layer coding is performed on the second AVC encoding using the first AVC encoding as a base layer, and
the enhancement layer coding of the given macroblock uses the coding mode of the second AVC encoding for the given macroblock, without reconstructing the given macroblock.

8. The method of claim 1 wherein merging comprises:
forming a base layer in the third AVC encoding, the base layer being occupied by at least part of the first AVC encoding; and
forming an enhancement layer in the third AVC encoding, the enhancement layer being occupied by at least part of the second AVC encoding, wherein forming the enhancement layer comprises coding a given macroblock in the second AVC encoding using motion information from a collocated macroblock in the base layer without performing motion compensation for the given macroblock.

9. The method of claim 1 wherein merging comprises:
forming a base layer in the third AVC encoding; and
forming an enhancement layer in the third AVC encoding, the enhancement layer being occupied by at least a portion of the first AVC encoding, wherein forming the enhancement layer comprises coding a given macroblock in the portion of the first AVC encoding to produce an enhancement layer residual, and performing residual re-encoding of the enhancement layer residual by using a predictor based on a residual of an encoding of a collocated macroblock in the base layer.

10. The method of claim 9 wherein performing residual re-encoding comprises;
reconstructing the base layer residual from DCT coefficients; and
upsampling, if needed, the reconstructed base layer residual to a resolution of the enhancement layer to produce the predictor.

11. The method of claim 1 wherein merging comprises:
using at least a portion of the first AVC encoding as a base layer in the third AVC encoding;
parsing syntax for the first AVC encoding;
parsing syntax for the second AVC encoding; and
using the parsed syntax of the first ACV encoding and the parsed syntax of the second AVC to encode to at least a portion of the second AVC encoding as an enhancement layer in the third AVC encoding.

12. The method of claim 11 wherein merging further comprises:
evaluating the parsed syntax for a given macroblock in the portion of the second AVC encoding;
evaluating the parsed syntax for a collocated macroblock in the portion of the first AVC encoding;
if the original coding mode of the given macroblock and the original coding mode of the collocated macroblock are intra-coding modes, then using a reconstruction of the collocated macroblock as a reference for the given macroblock;
if the original coding mode of the given macroblock and the original coding mode of the collocated macroblock are inter-coding modes, then using motion information from the collocated macroblock to code the given macroblock; and
if the original coding mode of the given macroblock and the original coding mode of the collocated macroblock are not both intra-coding modes nor both inter-coding modes, then using the coding mode of the given macroblock to code, the given macroblock;

13. (canceled)

14. The method of claim 1 wherein merging comprises:
using at least a portion of the first AVC encoding as a base layer in the third AVC encoding;
using at least a portion of the second AVC encoding as an enhancement layer in the third AVC encoding;
determining, for a given macroblock in the portion of the second AVC encoding, coding cost of one or more coding modes that use the base layer as a reference; and
selecting from the one or more coding modes a coding mode to use in coding the given macroblock, the selecting being based on the evaluating.

15.-16. (canceled)

17. The method of claim 1 wherein merging comprises:
using at least a portion of the first AVC encoding as a base layer in the third AVC encoding;
using at least a portion of the second AVC encoding as an enhancement layer in the third AVC encoding;
fully decoding at least the portion of the second AVC encoding into a pixel-domain data sequence;
parsing syntax of at least the portion of the first AVC encoding; and
providing the pixel-domain data sequence and the parsed syntax to an SVC enhancement layer encoder to generate the enhancement layer.

18. The method of claim 1 wherein merging comprises:
using at least a portion of the first AVC encoding as a base layer in the third AVC encoding; and
re-encoding at least the portion of the first AVC encoding so that it conforms to the requirements of a reference layer in an SVC bitstream.

19. (canceled)

20. The method of claim 1 wherein merging comprises:
decoding the first AVC encoding;
re-encoding the decoded first AVC encoding; and
occupying the first layer with the re-encoded first AVC encoding, wherein the first AVC encoding occupies the first layer in the form of the re-encoded first AVC encoding.

21. (canceled)

22. An apparatus comprising:
means for accessing a first AVC encoding of a sequence of data;
means for accessing a second AVC encoding of the sequence of data, the second AVC encoding differing from the first AVC encoding in quality; and
means for merging the first AVC encoding and the second AVC encoding into a third AVC encoding that uses the SVC extension of AVC, such that the first AVC encoding occupies at least a first layer in the third AVC encoding, and the second AVC encoding occupies at least a second layer in the third AVC encoding, and wherein at least one of the first or second layers is a reference layer for the other of the first or second layers.

23. A transcoder configured to perform at least the following:
accessing a first AVC encoding of a sequence of data;
accessing a second AVC encoding of the sequence of data, the second AVC encoding differing from the first AVC encoding in quality; and
merging the first AVC encoding and the second AVC encoding into a third AVC encoding that uses the SVC extension of AVC, such that the first AVC encoding occupies at least a first layer in the third AVC encoding, and the second AVC encoding occupies at least a second layer in the third AVC encoding, and wherein at least one of the first or second layers is a reference layer for the other of the first or second layers.

24. (canceled)

25. A processor readable medium having stored thereon instructions for causing one or more processors to collectively perform at least the following:
accessing a first AVC encoding of a sequence of data;
accessing a second AVC encoding of the sequence of data, the second AVC encoding differing from the first AVC encoding in quality; and
merging the first AVC encoding and the second AVC encoding into a third AVC encoding that uses the SVC extension of AVC, such that the first AVC encoding occupies at least a first layer in the third AVC encoding, and the second AVC encoding occupies at least a second layer in the third AVC encoding, and wherein at least one of the first or second layers is a reference layer for the other of the first or second layers.

26.-27. (canceled)

28. The method of claim 1 wherein a block of one of the first AVC encoding or the second AVC encoding serves as a reference block for encoding a block from the other of the first AVC encoding or the second AVC encoding.
